(19) United States
(12) Patent Application Publication
(10) Pub. No.: US 2026/0008108 A1
(43) Pub. Date: Jan. 8, 2026

(54) Device for Machining, in Particular for Deep-Rolling, Shafts

(71) Applicant: Hegenscheidt-MFD GmbH, Erkelenz (DE)

(72) Inventors: Christian Henk, Erkelenz (DE); Roland Heffe, Korschenbroich (DE)

(21) Appl. No.: 19/111,905

(22) PCT Filed: Aug. 21, 2023
(86) PCT No.: PCT/EP2023/072879

§ 371 Date: Mar. 14, 2025

(30) Foreign Application Priority Data
Sep. 15, 2022 (DE) 10 2022 123 633.1

(51) Int. Cl. B23B 13/02

(52) U.S. Cl. CPC B23B 13/02

(57) ABSTRACT

A device is represented and described for machining, in particular for deep-rolling, shafts and other components, including two live centres for receiving a shaft to be machined on both sides, at least one drive for rotating the shaft to be machined, at least one pair of rolling tools for machining, in particular deep-rolling the shaft to be machined. The two live centres are arranged on a central axis, wherein at least one live centre is displaceable along the central axis. At least one pair of rolling tools is arranged on a movable axial slide, which is displaceable along the central axis. The rolling tools are displaceable in the radial direction relative to the central axis. In order to achieve efficient machining of components with different geometries, at least one changing apparatus is provided for changing the rolling tools. The use of a device of this type for deep-rolling shafts, in particular wheelset shafts of wheelsets for rail vehicles, is also represented and described.

### CROSS-REFERENCE TO RELATED APPLICATIONS

This application is the United States national phase of International Patent Application No. PCT/EP2023/072879, filed Aug. 21, 2023, and claims priority to German Patent Application No. 10 2022 123 633.1, filed Sep. 15, 2022, the disclosures of which are hereby incorporated by reference in their entireties.

### BACKGROUND OF THE INVENTION

### Field of the Invention

The invention relates to a device for machining, in particular for deep-rolling, shafts and other components, comprising: two live centres for receiving a shaft to be machined on both sides, at least one drive for rotating the shaft to be machined, at least one pair of rolling tools for machining, in particular for deep-rolling, the shaft to be machined, wherein the two live centres are arranged on a central axis, wherein at least one live centre is displaceable along the central axis, wherein at least one pair of rolling tools is arranged on a movable axial slide, which is displaceable along the central axis, and wherein the rolling tools are displaceable in the radial direction relative to the central axis.

The invention also relates to the use of a device of this type for deep-rolling shafts, in particular wheelset shafts of wheelsets for rail vehicles.

The machining of shafts is in particular highly relevant in the area of wheelsets for rail vehicles, as the durability of wheelset axles and wheelset shafts can be significantly increased by deep-rolling. During deep-rolling, suitable rolling bodies are guided or rolled over the component surface to be machined under contact pressure. Different effects occur in the region of the surface or the edge layer of the machined material, for example the surface is smoothed (small notches are levelled out) and the material is plastically deformed and thereby solidified. In addition, undesirable residual stresses that may be present in the workpiece edge layer can be reduced by deep-rolling; likewise, a favourable residual stress state in the region of the edge layer can be built up by deep-rolling, in particular favourable compressive residual stresses can be generated. All this leads to deep-rolled wheelset shafts withstanding the different loads acting on them better than non-deep-rolled wheelset shafts; therefore, deep-rolling can greatly increase the service life of wheelsets and other similarly loaded components, which can be demonstrated, for example, by endurance vibration tests.

### Description of Related Art

For example, a machine for deep-rolling wheelset shafts is known from EP 2 588 273 B1. The machine described there is used for deep-rolling wheelset shafts of wheelsets for rail vehicles. The machine has two live centres between which the wheelsets to be machined are rotatably clamped. In addition, the machine has a plurality of pairs of deep-rolling tools that are movable relative to the wheelsets.

A disadvantage of devices of this type is that the tools can only be changed manually with great effort due to their arrangement and limited mobility. For example, a change may be necessary if a different region of the shaft or a different shaft is to be machined and a rolling body with a different geometry is to be used for this purpose. Among other things, the complex changing processes mean that devices of this type are often only used for a very limited purpose, for example for deep-rolling wheelsets with largely identical geometry.

### SUMMARY OF THE INVENTION

Against this background, the object of the invention is to configure and further develop the device described at the outset in such a manner that it is possible to efficiently machine components with different geometries.

In the case of a device as described herein, this object is achieved by at least one changing apparatus for changing the rolling tools.

The invention relates to a device for machining, in particular for deep-rolling, shafts and other components. In addition to deep-rolling, the device can also be used for other machining processes, for example for polish rolling, smooth rolling or straightening or turning. Long, cylindrical components are preferably machined, in particular shafts of wheelsets for rail vehicles. The device initially comprises two live centres for receiving a shaft to be machined on both sides. The live centres ensure that the shaft to be machined can be held securely, but still rotatably, in the device at its two opposite end surfaces. For example, the live centres may be conically shaped. The two live centres are arranged on a central axis, which corresponds to the axis of rotation of the shaft when the shaft is clamped. In addition, at least one live centre is displaceable along the central axis (i.e. in the axial direction). Alternatively, it is possible for both live centres to be displaceable along the central axis (i.e. in the axial direction). The axial distance between the two centre axes is therefore adjustable such that shafts of different length can be clamped and machined, for example shafts with a length of up to 3000 mm. The diameters of the shafts to be machined can be in the range between 50 mm and 500 mm. The device also comprises at least one drive for rotating the shaft to be machined. Two or more drives may also be provided. The drive power of the at least one drive can be transmitted to the shaft in order to rotate it. Preferably, the relative movement required for machining between the shaft to be machined and the rolling tools is achieved by a movement (rotation) of the shaft and not by a movement of the rolling tools around the shaft. Depending on the machining method, the shaft rotates at speeds between 20 rpm and 400 rpm. The device further comprises rolling tools arranged in pairs, with a pair being formed by two rolling tools arranged on opposite sides of the shaft. The rolling tools are displaceable in the radial direction relative to the central axis, so they can be moved in the direction towards and away from the shaft. The rolling tools are used to machine the shaft by pressing them onto the surface of the rotating shaft. This is done with rolling forces of 2,000 N to 50,000 N. At least one pair of rolling tools is arranged on a movable axial slide, which is displaceable along the central axis. Preferably, all pairs of rolling tools are arranged on an axial slide of this type. In this way, the rolling tools can be moved to the machining position of the shaft.

According to the invention, the device is supplemented by at least one changing apparatus for changing the rolling tools. A changing apparatus is understood to be an apparatus which can change the rolling tools at least partially automatically, but preferably fully automatically. This has the advantage that the rolling tools can be changed with very few or no manual interventions. By changing the rolling tools (partially or fully) automatically, set-up times can be significantly reduced such that the device can be used more productively. Another advantage of the faster option of changing tools is that the device can be used more flexibly for different machining tasks and different components and thus works economically even with small quantities or batch sizes.

According to one configuration of the device, it can be provided that the changing apparatus is movable, in particular mounted so as to be rotatable about an axis of rotation and/or displaceable in the vertical direction. The mobility of the changing apparatus means that tools can be changed particularly efficiently and smoothly, since the changing apparatus can receive the tool to be changed, remove it from the machining position and bring another tool into the machining position.

According to one configuration of the device, it is provided that the changing apparatus has at least two, in particular at least four receptacles for rolling tools. Since the changing apparatus has a plurality of receptacles for rolling tools, the device can be equipped with different rolling tools for different machining tasks (e.g. deep-rolling or straightening) and/or for different component geometries (e.g. different diameters). In addition, storing rolling tools in the changing apparatus leads to even faster tool changes, as the distances covered by the tools are as short as possible.

According to a further configuration of the device, it is provided that the changing apparatus has a clamping device for releasing and clamping the rolling tools. If the changing apparatus not only controls the supply and removal of rolling tools, but also the release and clamping of rolling tools by way of a clamping device, the tool change can be carried out fully automatically, i.e. without manual intervention. This further reduces set-up times and also ensures error-free, consistent fixing of the deep-rolling tools.

In a further design of the device, it is provided that the changing apparatus is arranged in the region of the live centres. In other words, it is provided that the changing apparatus—seen in the axial direction of the shaft—is not arranged “next to” the shaft, but “in front of” and “behind” the shaft. This arrangement is particularly space-saving and compact and enables collision-free machining of the shaft by the rolling tools, even with large diameter shafts. This is because the described arrangement of the changing apparatus does not require any installation space close to the workpiece, which means that the machining options remain unrestricted. Changing the shafts to be machined is also made considerably easier by the described arrangement of the changing apparatuses.

According to a further configuration of the device, two or more pairs of rolling tools are provided. By increasing the number of rolling tool pairs, particularly long shafts can also be machined quickly. Two pairs of rolling tools have proven to be particularly advantageous, as two pairs of rolling tools can also be changed automatically: The first pair of rolling tools can be moved to one side of the device (in the axial direction “in front of” the shaft) and changed by changing apparatuses arranged therein and the second pair of rolling tools can be moved to the opposite side of the device (in the axial direction “behind” the shaft) and changed by changing apparatuses arranged therein. These two “outer” pairs of rolling tools can be supplemented by a third or further pairs of rolling tools in between, which can be changed manually, for example.

According to a further configuration of the device, it is provided that at least one pair of rolling tools is arranged on a movable axial slide, which is displaceable along the central axis. The arrangement on slides has the advantage that two opposingly arranged rolling tools can be arranged on the same axial slide, thereby ensuring that these two rolling tools always occupy the same axial position, i.e. are always precisely “opposingly” arranged. In addition, this arrangement means that the axial slide can absorb the rolling forces of both rolling tools, which is particularly favourable in terms of design, since the two rolling forces of a pair of rolling tools are directed in opposite directions and are equal (in terms of amount) and therefore reliably compensate or cancel each other out. Preferably, the axial slide is arranged in the vertical direction under the shaft. It is also preferred that each pair of rolling tools is arranged on a (separate) axial slide in each case; thus, all pairs should have their own axial slide.

In relation to this configuration, it is further proposed that on at least one axial slide are arranged two radial slides which are displaceable in the radial direction and on each of which is arranged a rolling tool. By combining axial slides with radial slides, the rolling tools can be moved not only in the axial direction, but also in the radial direction, allowing the rolling tools to be moved two-dimensionally in a horizontally arranged plane. Unlike with the axial slides, a pair of rolling tools cannot “share” a common radial slide, as they have to perform opposite movements in the radial direction during operation and have to receive the shaft between them in a “pincer-like” manner. Two radial slides each “share” an axial slide. Preferably, two radial slides that are displaceable in the radial direction are arranged on all axial slides.

In relation to this configuration, it is also proposed that a shaft support that is displaceable in the vertical direction is arranged on at least one axial slide. Preferably, a shaft support that is displaceable in the vertical direction is arranged on at least two axial slides, in particular on the two outer axial slides. The shaft supports (also “support prisms”) are used to load the device with shafts of different diameters. For this purpose, the shaft supports preferably have an upper side that enables (self-)centring of the shaft parallel to the central axis, for example a V-shaped or U-shaped upper side. The vertical adjustability of the shaft supports enables shafts with different diameters to be brought to a height suitable for clamping between the two live centres. After clamping the shaft, the shaft supports can be moved down again to release the shaft for machining. Arranging the shaft support on the axial slide means that an axial displacement of the axial slide also leads to an axial displacement of the shaft support, which makes it easier to adapt to shafts of different lengths, for example. In addition, an arrangement of the shaft support on the axial slide has the advantage that no collision with the shaft support is to be feared in the event of an axial displacement of the axial slide (unlike an arrangement of the shaft support between two axial slides). It may be provided that the shaft support has a measuring apparatus. This has the advantage that the shaft can be measured (in particular the axial position of the shaft in the device or the concentricity of the shaft can be recorded) while it lies on the shaft supports such that the measurement data can be used for machining the shaft after clamping the shaft.

According to a further configuration of the device, it is provided that at least one rolling tool is pivotably mounted, in particular is pivotable by at least 90° on both sides relative to the central axis. Preferably, all rolling tools are pivotably mounted in this manner; in any case, however, the rolling tools to which a changing apparatus is assigned. The rolling tools should preferably be pivotable in a horizontal plane—i.e. around a vertical axis of rotation. The pivotable mounting has several advantages. A first advantage is that the rolling tools can be tilted during the rolling process, i.e. they are not perpendicular to the axis of rotation of the shaft. This has the advantage, for example, that even hard-to-reach places can be reached, such as notches or offsets. A second advantage is that the pivotability of the rolling tools can be used for the tool changes and makes them easier. This is because when the rolling tools are pivoted by 90°, they are aligned parallel to the central axis and can be brought particularly close to the changing apparatus by displacing the axial slide.

According to a further design of the device, it is provided that each rolling tool is assigned a rolling cylinder, in particular a hydraulic rolling cylinder. Rolling cylinders (and corresponding pistons) can also reliably transfer very high rolling forces to the rolling tools, with hydraulic systems in particular having proven their worth. Preferably, the rolling tools are rotatably mounted via a fork on a piston, which can be retracted and extended into the corresponding rolling cylinder. The rolling cylinder is preferably mounted (possibly pivotably as described above) on the radial slide, which in turn is mounted on the axial slide and connects the rolling tools to the slides in a rotatably mounted and radially displaceable manner.

According to a further configuration of the device, it is provided that at least one pivotably mounted rolling tool has a vertical pivot axis which has a distance to a point of contact of rolling tool and shaft that is 50 mm or less, in particular 35 mm or less. The machining forces occurring during operation (e.g. rolling forces) are introduced into the rolling tool at the point of contact with the shaft. Due to their size, the machining forces can cause large torques, which can be supported less easily (e.g. by a motor) with a pivotable bearing than with a rigid bearing. It has therefore proven to be particularly advantageous to allow the pivot axis to run particularly close to the point of contact, ideally even through the point of contact (distance=0 mm). A reduced distance results in a smaller lever arm and thus lower torques around the pivot axis. In this way, the desired pivot position or angular position of the rolling tool can be precisely maintained during machining, even with high rolling forces. Design-wise, the reduction of the distance can be achieved, for example, by the pivot drive being arranged far “inside”, i.e. almost under the shaft, and connected to the rolling cylinders via a radially outwardly protruding arm. Preferably, all pivotably mounted rolling tools are designed in this manner.

In all configurations represented, the device described above is particularly suitable for use for deep-rolling shafts, in particular wheelset shafts of wheelsets for rail vehicles. Wheelsets of rail vehicles must be particularly resilient due to their very high mileage in order to achieve a long service life. Due to the high number of wheelsets in operation, only very cost-effective and efficient machining methods come into question, which makes the device according to the invention appear particularly suitable.

### BRIEF DESCRIPTION OF THE DRAWINGS

The invention will be explained in more detail below on the basis of a drawing that represents only one preferred exemplary embodiment. In the drawing:

FIG. 1: shows a top view of a device according to the invention with a shaft to be machined,

FIG. 2: shows a sectional view from above of the device from FIG. 1 without a shaft,

FIG. 3: shows the device from FIG. 1 in a position for changing the tools,

FIG. 4: shows an enlarged view of a part of the device from FIG. 1, and

FIG. 5: shows a part of the device from FIG. 1 in a side view along the section plane V-V drawn in FIG. 1.

### DESCRIPTION OF THE INVENTION

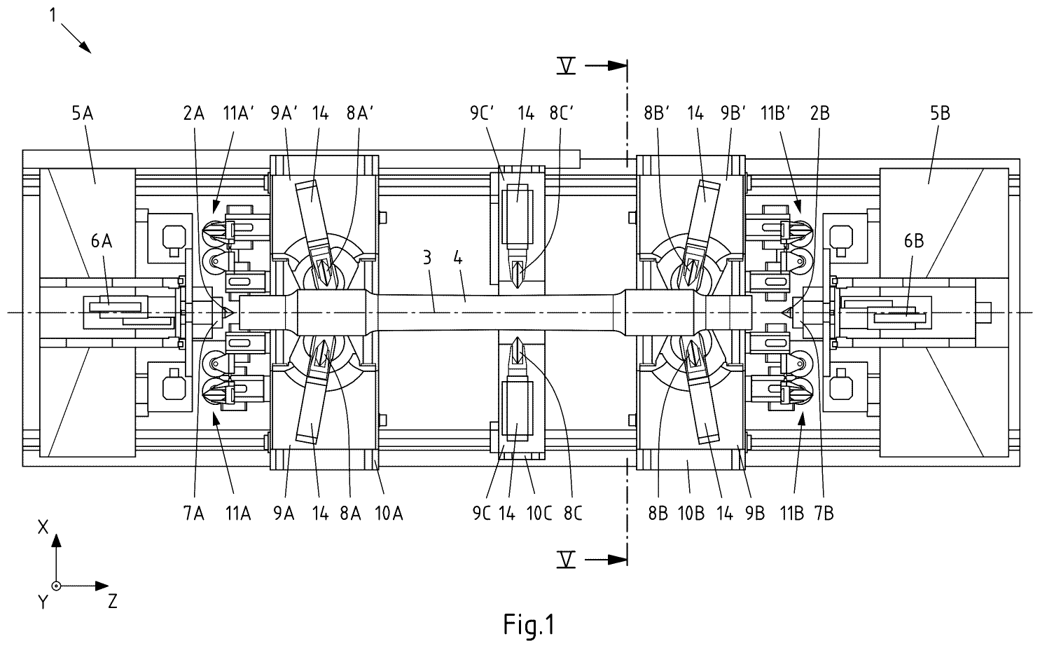

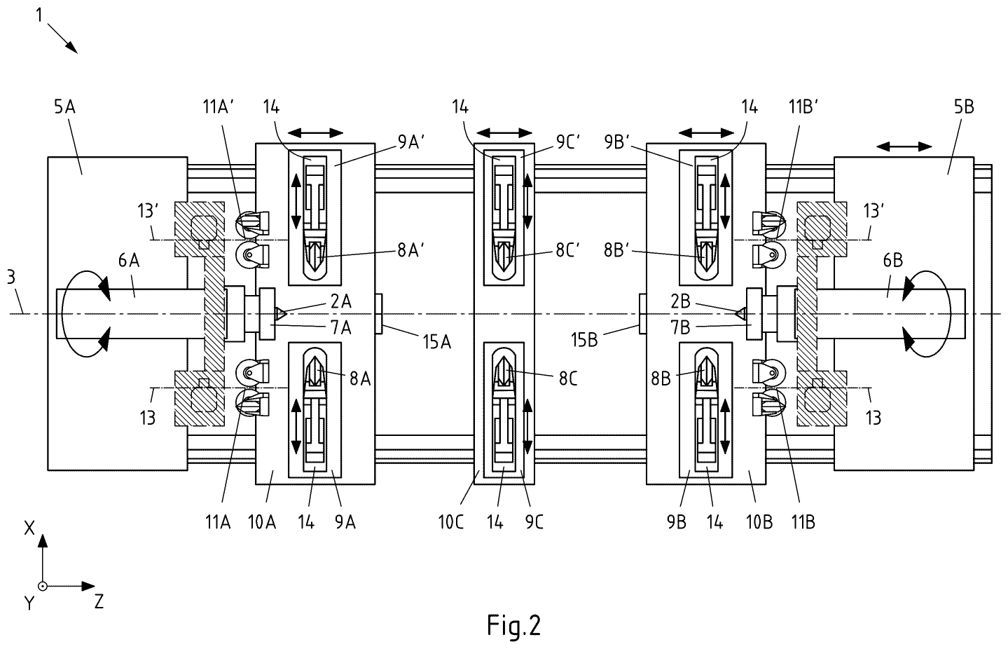

FIG. 1 shows a top view device 1 according to the invention with a shaft to be machined in a top view; FIG. 2 shows the device 1 from FIG. 1 without a shaft in a sectional view from above. The device 1 comprises two live centres 2A, 2B, which are arranged on a central axis 3. The central axis 3 extends in the z-direction, which together with a horizontal x-direction and a vertical y-direction forms a coordinate system. A shaft 4 to be machined can be clamped and thus received between the live centres 2A, 2B. In order to be able to machine shafts 4 of different lengths and to facilitate clamping, at least one of the two live centres 2 is displaceable along the central axis 3 such that the two live centres 2A, 2B can occupy different distances from one another, preferably distances between 0 mm and 3000 mm. For the configuration of the device 1 shown in FIG. 1 and FIG. 2 and preferred in this respect, the first live centre 2A represented on the left is arranged on a stationary spindle box 5A, while the second live centre 2B represented on the right is arranged on a movable tailstock 5B and is thus displaceable along the central axis 3.

The device 1 shown in FIG. 1 and in FIG. 2 further comprises at least one drive 6 for rotating the shaft 4 to be machined. For the configuration of the device 1 shown in FIG. 1 and FIG. 2 and preferred in this respect, a first drive 6A is arranged in the region of the first live centre 2A arranged on the left. In addition to this, a second drive 6B is arranged (although only optionally) in the region of the second live centre 2B arranged on the right. The transmission of the drive power to the shaft 4 to be machined takes place preferably via rotational drivers 7A, 7B, which are arranged next to the live centres 2A, 2B and can drive the shaft 4 frictionally and/or in a form-locking manner. The rotational movements of the drives 6A, 6B are each indicated in FIG. 2 by a circular double arrow.

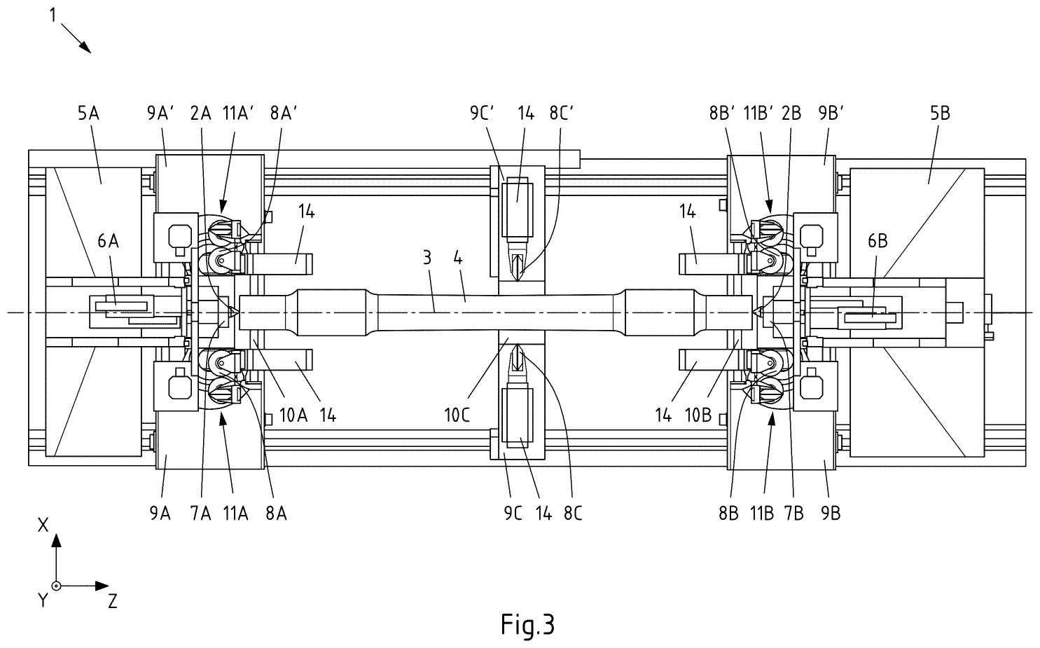

The device 1 from FIG. 1 and FIG. 2 also comprises three pairs of rolling tools 8 for deep-rolling the shaft 4 to be machined. Two first rolling tools 8A, 8A′ form a first pair, two second rolling tools 8B, 8B′ form a second pair and two third (middle) rolling tools 8C, 8C′ form a third pair. Each rolling tool 8 is assigned a hydraulic rolling cylinder 14, by way of which the rolling tools 8 can be pressed onto the shaft 4 to be machined with a defined rolling force. The rolling tools 8 can be moved in different directions: The rolling tools 8 are initially arranged so as to be displaceable (in cylindrical coordinates) in the radial direction (or in Cartesian coordinates: in the x-direction) relative to the central axis 3. Design-wise, this can be achieved by the rolling tools 8 being arranged on radial slides 9; in addition, a slight radial mobility is achieved by the rolling cylinders 14. The first rolling tools 8A, 8A′ are arranged (each with a rolling cylinder 14) on a first radial slide 9A, 9A′. Similarly, the second rolling tools 8B, 8B′ (each with a rolling cylinder 14) are arranged on a second radial slide 9B, 9B′ and the third (middle) rolling tools 8C, 8C′ are arranged (each with a rolling cylinder 14) on a third (middle) radial slide 9C, 9C′. The rolling tools 8 are also arranged so as to be displaceable (in cylindrical coordinates) in the axial direction (or in Cartesian coordinates: in the z-direction) along the central axis 3. This can be constructively achieved in that rolling tools 8 are arranged on axial slides 10 which are displaceable along the central axis 3: The first rolling tools 8A, 8A′ are arranged (via their first radial slide 9A, 9A′) on a first axial slide 10A. Similarly, the second rolling tools 8B, 8B′ are arranged (via their second radial slide 9B, 9B′) on a second axial slide 10B and the third rolling tools 8C, 8C′ are arranged (via their third radial slide 9C, 9C′) on a third (middle) axial slide 10C. The axial mobility of the axial slides 10A, 10B, 10C and the radial mobility of the radial slides 9A, 9A′, 9B, 9B′, 9C, 9C′ are indicated in FIG. 2 by double arrows. Two vertically adjustable shaft supports 15A, 15B (concealed in FIG. 1 and FIG. 3 by the shaft 4) can also be seen in FIG. 2, of which the first shaft support 15A is arranged on the first axial slide 10A and of which the second shaft support 15B is arranged on the second axial slide 10B.

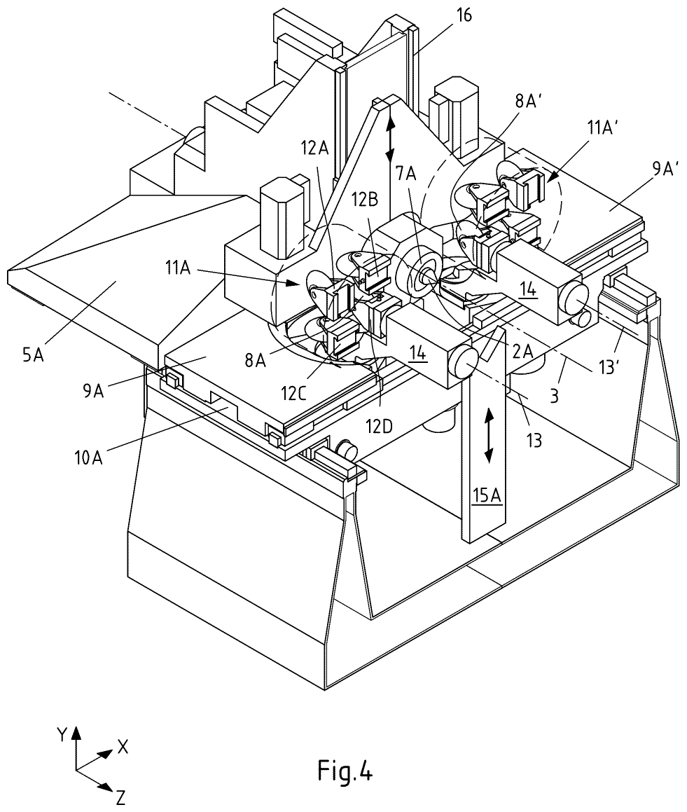

The device 1 represented in FIG. 1 and in FIG. 2 also comprises at least one changing apparatus 11 for changing the rolling tools 8. For the configuration of the device 1 shown in FIG. 1 and FIG. 2 and preferred in this respect, four changing apparatuses 11 are provided: Two first changing apparatuses 11A, 11A′ are arranged in the environment of the first live centre 2A and serve to change the two first rolling tools 8A, 8A′. In addition, two second changing apparatuses 11B, 11B′ are arranged in the environment of the second live centre 2B and serve to change the two second rolling tools 8B, 8B′. There are no changing apparatuses provided for the third (middle) rolling tools 8C, 8C′; these rolling tools 8C, 8C′ must therefore be changed manually. Each of the changing apparatuses 11 has four receptacles 12A to 12D for rolling tools 8, which will be discussed in more detail in connection with FIG. 4. The changing apparatuses 11 are rotatable in each case about an axis of rotation 13, 13′ (cf. FIG. 2 and FIG. 4) such that each of their receptacles 12 can be brought into an optimal position for changing the rolling tool 8. Preferably, the axes of rotation 13, 13′ run parallel to the central axis 3.

FIG. 3 shows the device from FIG. 1 in a position for changing the rolling tools 8. The features already described in connection with FIG. 1 or FIG. 2 are provided with corresponding reference numerals in FIG. 3. In order to enable automatic changing of the rolling tools 8, the two outer axial slides 10A, 10B have been moved to the outermost positions; the first axial slide 10A has thus been moved to the far left, i.e. in the direction of the first live centre 2A, and the second axial slide 10B has been moved to the far right, i.e. in the direction of the second live centre 2B. In addition, the first rolling tools 8A, 8A′ (with their rolling cylinders 14) have been pivoted in each case by 90° in the direction of the first live centre 2A such that the first rolling tools 8A, 8A′ are arranged directly in front of the first changing apparatuses 11A, 11A′. Similarly, the second rolling tools 8B, 8B′ (with their rolling cylinders 14) have been pivoted in each case by 90° in the direction of the second live centre 2B such that the second rolling tools 8B, 8B′ are arranged directly in front of the second changing apparatuses 11B, 11B′. In this position, the rolling tools 8A, 8A′, 8B, 8B′ can be changed automatically on the two outer machining units (axial slides 10A, 10B). On the middle (optional) machining unit (axial slide 10C), however, the rolling tools 8C, 8C′ must be changed manually.

FIG. 4 shows an enlarged view of a part of the device from FIG. 1. The features already described in connection with FIG. 1 to FIG. 3 are provided with corresponding reference numerals in FIG. 4. In FIG. 4, for reasons of better clarity, only the left half of the device 1 is represented, i.e. the environment of the spindle box 5A and the first live centre 2A. The position pivoted by 90° of the two rolling tools 8A, 8A′ and their rolling cylinder 14 can be clearly seen in FIG. 4. It can also be seen that the two changing apparatuses 11A, 11A′ each have four receptacles 12A to 12D. The two rolling tools 8A, 8A′ are inserted in one of the four receptacles 12A to 12D in the position shown, while the other three of the four receptacles 12A to 12D are equipped with other tools that can be placed on the rolling cylinders 14 by the receptacles 12A to 12D of the changing apparatuses 11A, 11A′ rotating about the axes of rotation 13, 13′ (indicated by dashed circular lines in FIG. 4) until the desired tool is in the desired position and an automatic change can take place. Lastly, the arrangement of the first shaft support 15A on the first axial slide 10A can also be seen in FIG. 4, which has a V-shaped upper side for support of the shaft 4 (not shown in FIG. 4) and is displaceable in the vertical direction relative to the first axial slide 10A (indicated by a double arrow). The changing apparatuses 11A, 11A′ are preferably displaceable in the vertical direction, for example by being able to be displaced upwards or downwards along a guide 16 (also indicated by a double arrow).

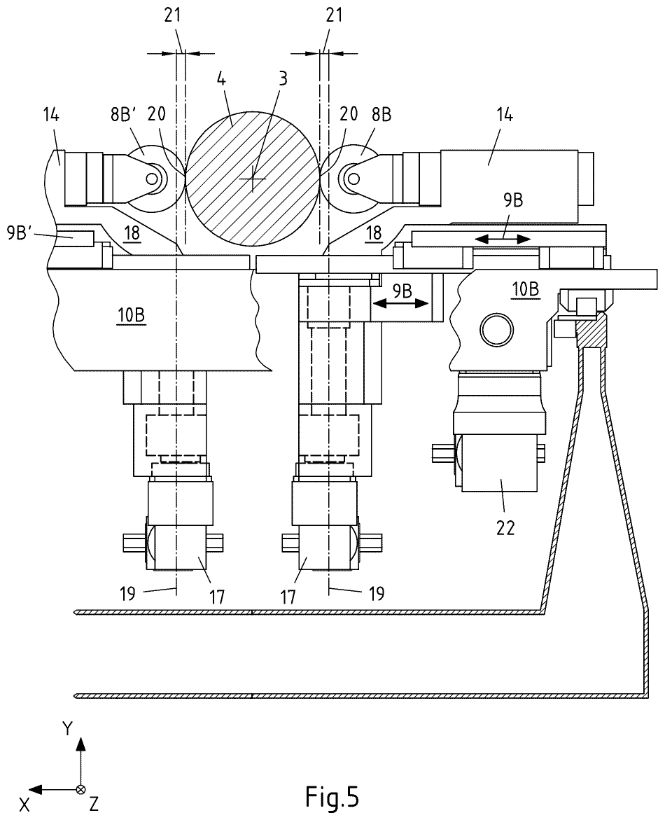

FIG. 5 lastly shows a part of the device 1 from FIG. 1 in a side view along the section plane V-V drawn in FIG. 1. In the side view, the constructive implementation of the pivoting bearing of the rolling tools 8B, 8B′ as well as the rolling cylinder 14 assigned thereto is particularly easily recognisable: The two radial slides 9B, 9B′ each have a pivot drive 17. The pivot drives 17 are each connected to a rolling cylinder 14 via an arm 18. The rolling cylinders 14 (and the rolling tools 8B, 8B′ mounted thereon) can therefore be pivoted in both opposing directions of rotation by way of the pivot drives 17 in each case about a vertically running pivot axis 19. The pivot axes 19 run as close as possible to points of contact 20 through which the rolling tools 8B, 8B′ transmit the machining forces (e.g. rolling forces) to the shaft 4. Preferably, the pivot axes 19 and the points of contact 20 form a distance 21 in the range between 0 mm and 50 mm, in particular between 0 mm and 35 mm (in the radial direction in a horizontal plane). This reduces the torques caused by the machining forces (e.g. rolling forces) that could unintentionally change the desired pivot position of the rolling tools during machining. Furthermore, a radial drive 22 can be seen in FIG. 5, which can displace the radial slide 9B in the radial direction (correspondingly, the opposite radial slide 9B′ has a radial drive 22 (not shown)). However, FIG. 5 only shows the second rolling tools 8B, 8B′ and the second radial slides 9B, 9B′ for reasons of better clarity, the embodiments can be transferred to the first rolling tools 8A, 8A′ and the first radial slides 9A, 9A′, since the first rolling tools 8A, 8A′ are pivotably mounted in a corresponding manner.

### LIST OF REFERENCE NUMERALS

1: Device
2, 2A, 2B: Live centre
3: Central axis
4: Shaft
5A: Spindle box
5B: Tailstock
6, 6A, 6B; Drive
7, 7A, 7B: Rotational driver
8, 8A, 8A′, 8B, 8B′, 8C, 8C′: Rolling tool
9, 9A, 9A′, 9B, 9B′, 9C, 9C′: Radial slide
10, 10A, 10B, 10C: Axial slide
11, 11A, 11A′, 11B, 11B′: Changing apparatus
12, 12A, 12B, 12C, 12D: Receptacle
13, 13′: Axis of rotation
14: Rolling cylinder
15A, 15B: Shaft support
16: Guide
17: Pivot drive
18 Arm
19 Pivot axis
20 Point of contact
21: Distance
22: Radial drive

1-13. (canceled)

14. A device for machining, comprising:
two live centres for receiving a shaft to be machined on both sides,
at least one drive for rotating the shaft to be machined,
at least one pair of rolling tools for machining, the shaft to be machined,
wherein the two live centres are arranged on a central axis,
wherein at least one live centre is displaceable along the central axis,
wherein at least one pair of rolling tools is arranged on a movable axial slide, which is displaceable along the central axis,
wherein the rolling tools are displaceable in the radial direction relative to the central axis, and
wherein at least one pair of rolling tools is arranged on a movable axial slide, which is displaceable along the central axis,
wherein at least one changing apparatus for changing the rolling tools and in that on at least one axial slide is arranged a shaft support that is displaceable in the vertical direction.

15. The device according to claim 14, wherein the at least one changing apparatus is rotatable about an axis of rotation and/or displaceable in the vertical direction.

16. The device according to claim 15, wherein the changing apparatus has at least two receptacles for rolling tools.

17. The device according to claim 14, wherein the changing apparatus has a clamping device for releasing and clamping the rolling tools.

18. The device according to claim 14, wherein the changing apparatus is arranged in the region of the live centres.

19. The device according to claim 14, comprising two or more pairs of rolling tools.

20. The device according to claim 14, wherein on at least one axial slide are arranged two radial slides which are displaceable in the radial direction and on each of the radial slides is arranged a rolling tool.

21. The device according to claim 14, wherein at least one rolling tool is pivotably mounted on both sides relative to the central axis.

22. The device according to claim 14, wherein each rolling tool is assigned a rolling cylinder.

23. The device according to claim 21, wherein at least one pivotably mounted rolling tool has a vertical pivot axis, which has a distance to a point of contact of rolling tool and shaft that is 50 mm or less.

24. (canceled)
